(19) United States
(12) Patent Application Publication
(10) Pub. No.: US 2016/0087879 A1
(43) Pub. Date: Mar. 24, 2016

(54) COMMUNICATION SYSTEM, NODE DEVICE, NODE PROGRAM, AND COMMUNICATION PROGRAM

(71) Applicant: HITACHI, LTD., Tokyo (JP)

(72) Inventors: Daisuke MATSUBARA, Tokyo (JP); Yasushi KASUGAI, Tokyo (JP)

(73) Assignee: HITACHI, LTD., Tokyo (JP)

(21) Appl. No.: 14/815,248

(22) Filed: Jul. 31, 2015

(30) Foreign Application Priority Data
Sep. 24, 2014 (JP) 2014-194119

(51) Int. Cl. H04L 12/707

(52) U.S. Cl. CPC H04L 45/22

(57) ABSTRACT

A communication system constituted by a plurality of nodes connected to each other via a network includes: a first node that receives a publish message for requesting for transmission of an object, from a publisher terminal; and a second node. Each of the nodes from the first node to the second node: has a storage unit in which first routing information is recorded; performs a first routing; and records, in the storage unit, an object ID of the publish message and second routing information. The communication system also includes a third node that receives a subscribe message for requesting for receipt of the object, from a subscriber terminal. Each of the nodes from the third node to the first node: performs a second routing; and records, in the storage unit, an object ID of the subscribe message, and third routing information.

### CROSS REFERENCE TO RELATED APPLICATIONS

This application claims the benefit of Japanese Patent Application No. 2014-194119 filed on Sep. 24, 2014, the disclosure of which is incorporated herein by reference.

### BACKGROUND

Subject matters disclosed herein are directed to a communication system, a node device, a node program, and a communication program.

A data transfer method by which a data is transferred from a data transmitting terminal to a data receiving terminal can be classified into: a “pull-type” in which the receiving terminal explicitly makes a request for transmitting the data; and a “push-type” in which the data is transmitted without having to make such a data transmission request each time.

In the pull-type data transfer method, a terminal of a registerer registers a data to be transmitted, and a terminal of a retriever retrieves the registered data.

In the push-type data transfer method, a terminal of a subscriber subscribes for permission of transmitting a data to the subscriber himself/herself, and a terminal of a publisher publish the subscribed data to the subscriber terminal.

The term “subscribe” herein means a pre-registration such that a data as a target for a subscribe is transmitted to a subscriber.

Both the pull-type and the push-type need to route a path through which the data passes from a data transmission side (an upstream side) to a data reception side (a downstream side). It is thus necessary for a node on the path of the data to determine to which of downstream adjacent nodes the node itself transfers the data having been transferred from an upstream adjacent node.

In order that the node determines the transfer destination of the node, it is required to use an ID (identifier) indicating a location on a network. On an IP (Internet Protocol) network, for example, an IP address as a location ID is used for identifying a location of a node with which establishes communication. A key to identify the IP address includes a host ID extracted from a URI (Uniform Resource Identifier) of a desired data.

The DNS (Domain Name System) is a name resolution service for identifying, using a host ID as a search key, a location ID indicated by the host ID. A terminal uses an IP address notified by the DNS for establishing communication with a destination node.

The DCN (Data-centric Network) is a network for routing a data request to a desired object using a data ID (an object ID).

Matteo D'Ambrosio, et al. “D-6.2 Second NetInf Architecture Description”, The FP4WARD Project, Jan. 14, 2010 (which may also be referred to as Non-Patent Document 1 hereinafter) discloses a technique in which a hierarchical DHT (Distributed Hash Table) transforms a host ID into a location ID, and to thereby realize a pull-type communication method in the DCN.

Teemu Koponen, et al. “A Data-Oriented (and Beyond) Network Architecture”, SIGCOMM'07, August 2007 (which may also be referred to as Non-Patent Document 2) discloses a technique in which path information is recorded while registering, to thereby realize a pull-type communication method.

M. Ain, et al. “D2.3 Architecture Definition, Component Descriptions, and Requirements”, Deliverable, PSIRP 7th FP EU-funded project, February 2009. (which may also be referred to as Non-Patent Document 3) discloses a technique in which a rendezvous system transforms a rendezvous ID into path information, to thereby realize a pull-type communication method.

Japanese Laid-Open Patent Application, Publication No. 2009-278624 discloses a contents centric network (CCN) in which a network is responsible for routing contents from a provider to a consumer (paragraph 0018, etc.).

### SUMMARY

In the push-type data transfer method, in some cases, a number of subscribes are registered to one registered data. If a transmission frequency of subscribe messages is high, a large transaction load is generated because the subscribe messages concentrate on a node at which matching between a publisher and a subscriber is performed (which will be referred to as a matching node hereinafter).

The present disclosure has been made in an attempt to solve the above-described problem and to realize load distribution of the subscribe messages in the push-type data transfer method.

A communication system of the present disclosure, which is constituted by a plurality of nodes connected to each other via a network includes: a first node which is one of a plurality of the nodes used for the communication system, that receives a publish message for requesting for transmission of an object, from a publisher terminal; and a second node which is different from the first node of a plurality of the nodes.

Each of the nodes from the first node to the second node: has a storage unit of its own in which first routing information showing a nexthop node as a transfer destination of the publish message is recorded; performs a first routing in which the publish message is transferred to the nexthop which is obtained from the first routing information; and records, in the storage unit of its own, an object ID of the publish message transferred using the first routing, and second routing information in which an adjacent node having transferred the publish message to the node itself is determined as a nexthop.

The communication system also includes a third node which is different from the first node and the second node of a plurality of the nodes, that receives a subscribe message for requesting for receipt of the object, from a subscriber terminal.

Each of the nodes from the third node to the first node: performs a second routing in which the subscribe message is transferred to the nexthop which is obtained by searching the second routing information for a object ID of the subscribe message or to a pre-set default nexthop; and records, in the storage unit of its own, the object ID of the subscribe message transferred using the second routing, and third routing information in which an adjacent node having transferred the subscribe message to the node itself is determined as a nexthop.

The first node receives the publish message of the object from the publisher terminal one more time.

Each of the nodes from the first node to the third node performs a third routing in which the publish message having been received one more time is transferred to a nexthop which is obtained by searching the third routing information for an object ID of the publish message having been received one more time.

Other features of the present disclosure will be described hereinafter.

According to what is disclosed herein, in the second routing, the node which has recorded therein the second routing information transmits the subscribe message to the publisher terminal (that is, not to the second node but to the first node). The subscribe message can therefore reach the first node without passing through the second node. This can reduce a transaction load of the second node.

Aspects of the present disclosure are supported by descriptions in an embodiment to be described later as follows.

The first routing may also be referred to as a path of a first publish message (indicated by an arrow 192 in FIG. 2).

The second routing may also be referred to as a path of a second subscribe message (indicated by arrows 194, 195 in FIG. 2). The path may be, however, discontinued at an end of the arrow 194, and an arrow 195 may be skipped.

The third routing may also be referred to as a path of a third publish message (indicated by an arrow 196 in FIG. 2).

The first node may also be referred to as a node 102 in FIG. 2.

The second node may also be referred to as a node 106 in FIG. 2.

The third node may also be referred to as a node 109 in FIG. 2.

The first routing information may also be referred to as a publish transfer table 211 illustrated in FIG. 10A.

The second routing information may also be referred to as a subscribe transfer table 212 illustrated in FIG. 10D (with entries added to FIG. 10D, compared to FIG. 10B).

The third routing information may also be referred to as a publish transfer table 211 illustrated in FIG. 11B (with entries added to FIG. 11B, compared to FIG. 10C).

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example of a configuration of a push-type communication system according to an embodiment of the disclosure.

FIG. 2 is an explanatory diagram illustrating an example of communication paths of the push-type communication system according to the embodiment.

FIG. 3 is a diagram illustrating an example of a configuration of a node device according to the embodiment.

FIG. 4A is an explanatory diagram illustrating an example of a publish transfer table 211 and a publish message; and FIG. 4B, an example of a subscribe transfer table 212 and a subscribe message, according to the embodiment.

FIG. 5 is a sequence diagram illustrating an example of a routing processing of a first subscribe message according to the embodiment.

FIG. 6 is a sequence diagram illustrating an example of a routing processing of a first publish message according to the embodiment.

FIG. 7 is a sequence diagram illustrating an example of a routing processing of a second publish message according to the embodiment.

FIG. 8 is a sequence diagram illustrating an example of a routing processing of a second subscribe message according to the embodiment.

FIG. 9 is a sequence diagram illustrating an example of a routing processing of a third publish message according to the embodiment.

FIG. 10A is a diagram illustrating an example of the publish transfer table 211 before execution of the processing of FIG. 5; FIG. 10B, an example of the subscribe transfer table 212 before execution of the processing of FIG. 5; FIG. 10C, an example of the publish transfer table 211 after execution of the processing of FIG. 5; and FIG. 10D, an example of the subscribe transfer table 212 after execution of the processing of FIG. 6, according to the embodiment.

FIG. 11A is a diagram illustrating an example of the subscribe transfer table 212 after execution of the processing of FIG. 7; FIG. 11B, an example of the table 211 after execution of the processing of FIG. 8; and FIG. 11C, an example of the subscribe transfer table 212 after execution of the processing of FIG. 9, according to the embodiment.

FIG. 12 is a flowchart illustrating processings performed by node devices according to the embodiment.

### DETAILED DESCRIPTION OF THE EXEMPLARY EMBODIMENT

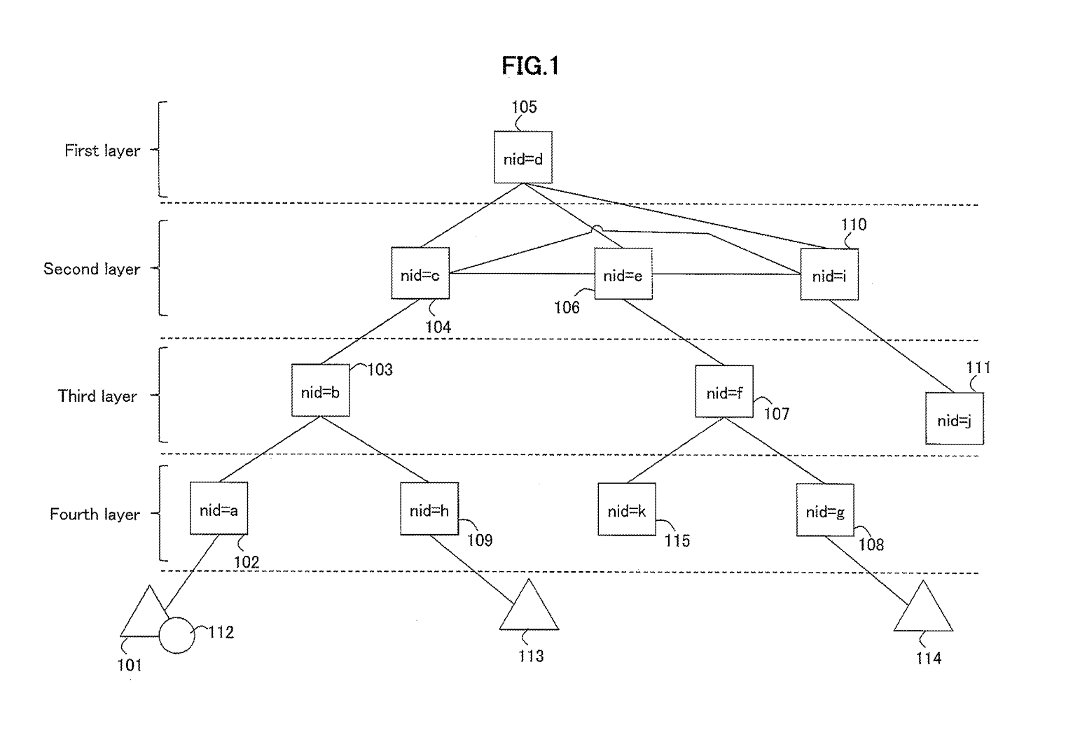

FIG. 1 is a diagram illustrating an example of a configuration of a push-type communication system.

The push-type communication system includes: nodes 102 to 113, 115; and terminals 101, 113, 114 accommodated in appropriate one of the nodes, which are connected via a network.

An object 112 herein means any data which is accessible using a data ID, such as a file in a multimedia format including video data and music data, text data including a Web page, and data for Machine-to-Machine (M2M) communication including sensor data and monitoring data on conditions of apparatus.

The terminal 101 is a publisher terminal that publishes the object 112.

The terminals 113, 114 are each a subscriber terminal that subscribes the object 112.

Note that each of the nodes and the terminals in the push-type communication system is configured as a computer having a CPU (Central Processing Unit), a memory, a hard disk (storage unit), and a network interface. The computer embodies processing units by executing a program loaded by the CPU into the memory.

The nodes are connected to each other in a hierarchical topology with the node 105 as a vertex at the top. In FIG. 1, dashed lines are provided between layers, so as to show which of the nodes belongs to the same layer. As described below, the smaller a number of the layer, the higher the layer.

A first (the highest) layer includes the node 105.

A second layer includes the nodes 104, 106, 110.

A third layer includes the nodes 103, 107, 111.

A fourth (the lowest) layer includes the nodes 102, 109, 115.

Next is described an example in which the push-type communication system is applied to a data-centric network (DCN). The DCN is a network for transferring an access to a desired object such as the object 112, to the desired object, using an object ID (which will be abbreviated as “oid” hereinafter) as an identifier of the object. Hence, in the push-type communication system, location information on the object 112 is managed by being distributed to respective tables (to be described in detail hereinafter) of the nodes.

A node ID (which will be abbreviated as “nid” hereinafter) is assigned to each of the nodes. The oid and the nid are different ID spaces and are different data from each other. A hierarchical representation of the oid will be described later.

The push-type communication system uses messages as follows, so as to instruct an access to the object 112:
a publish message which is a message packet used for transmitting the object 112 to a subscriber terminal (the terminals 113, 114) by the terminal 101; and
a subscribe message which is a message packet used for subscribing the object 112 by the terminals 113, 114.

Contents of a subscribe made by the subscriber terminal using the subscribe message may be any contents as exemplified below, as long as the contents allow an object (data) delivered to the subscriber terminal itself to be identified via a publish message:
pre-registration of transmission of a periodically delivered (a plurality of times) object such as an e-mail newsletter;
pre-registration of transmission of a non-periodically delivered object;
pre-registration of transmission of an object delivered just once; and
pre-registration of transmission of an object delivered only when a prescribed delivery condition is satisfied, such as an event notification including an error notification. In this case, even if the subscribe has been made, the object is not delivered until an error occurs.

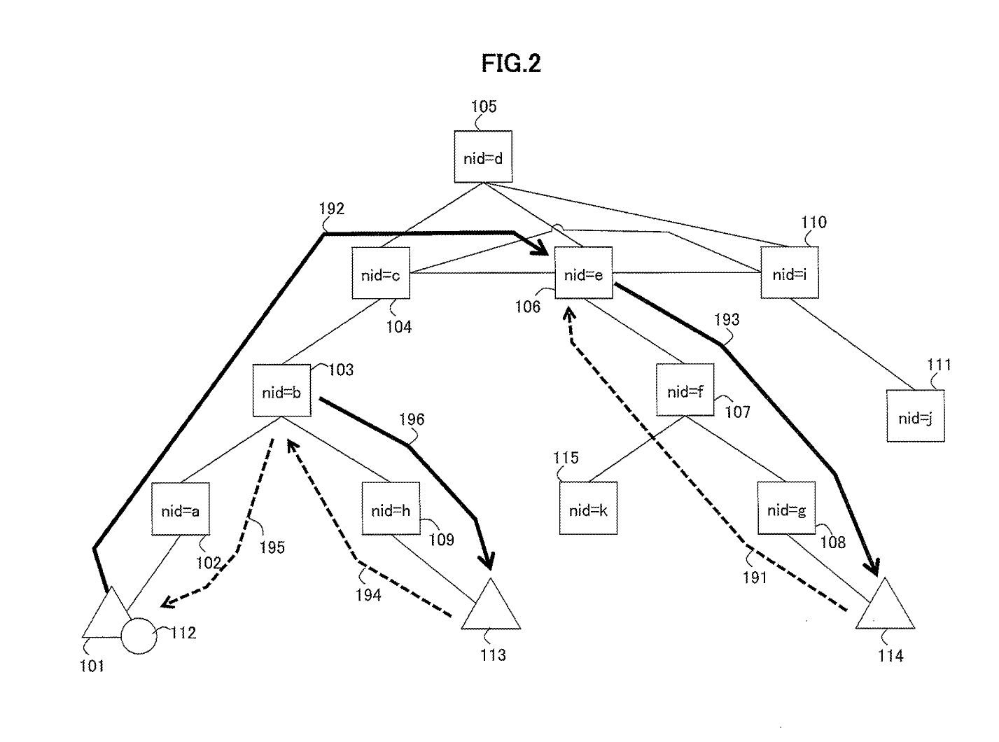

FIG. 2 is an explanatory diagram illustrating communication paths of publish messages (indicated by solid arrows) and subscribe messages (indicated by dashed arrows) in the push-type communication system of FIG. 1.

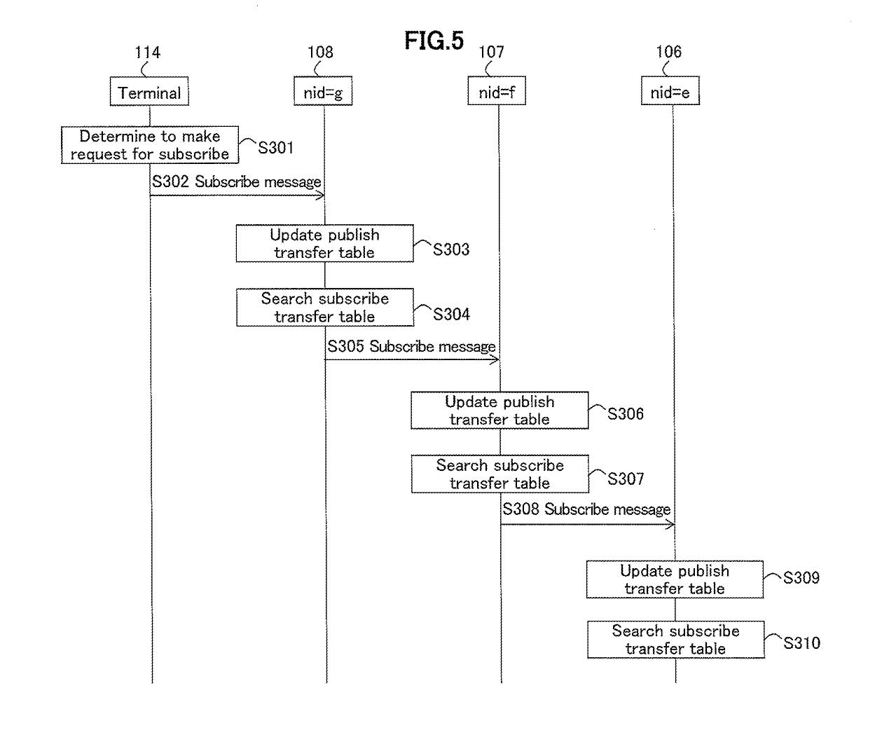

A dashed arrow 191 indicates a path of a first subscribe message (terminal 114→nid=g→f→e) (illustrated in detail in FIG. 5).

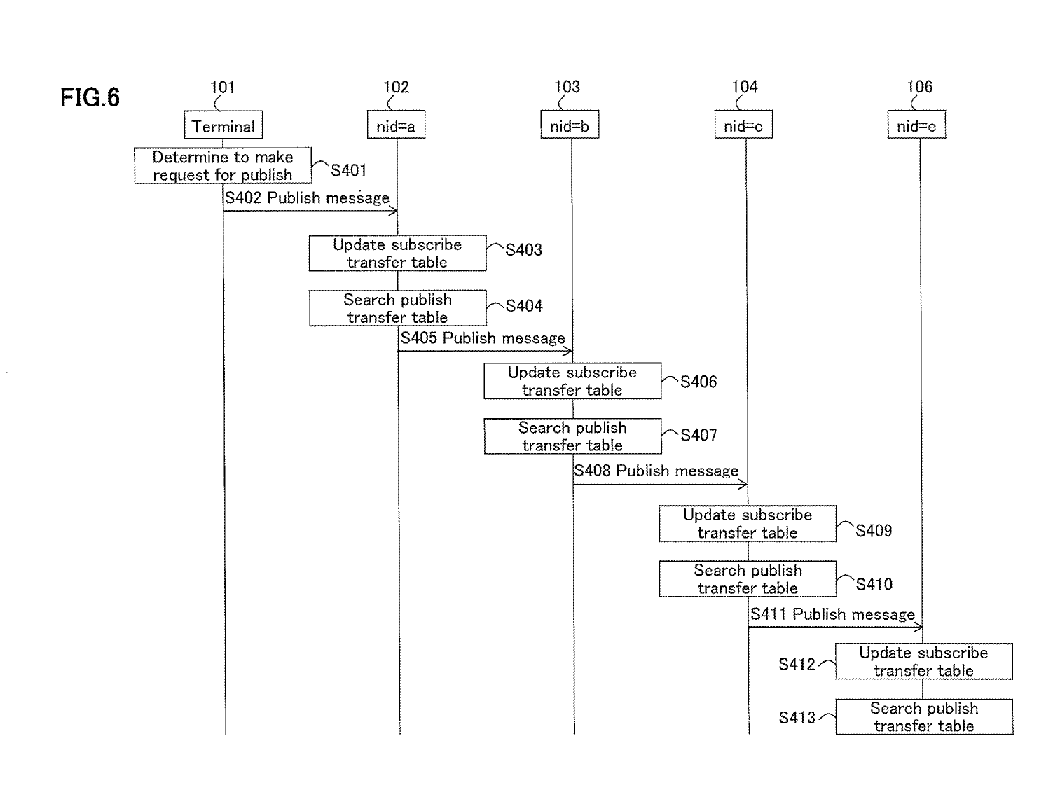

A solid arrow 192 indicates a path of a first publish message (terminal 101→nid=a→b→c→e) (illustrated in detail in FIG. 6).

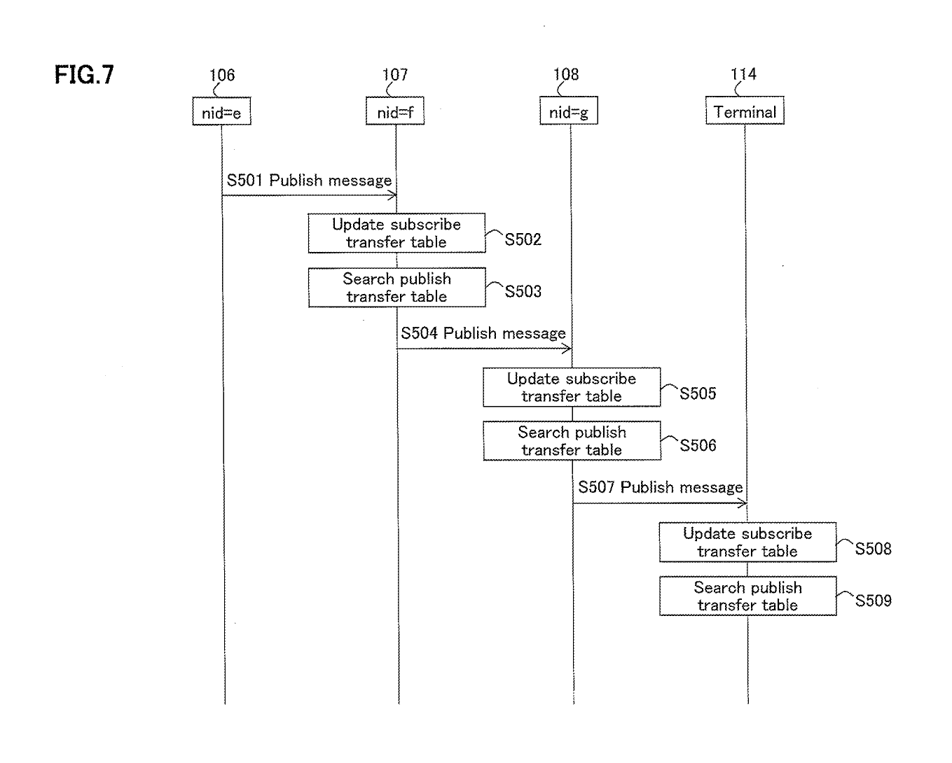

A solid arrow 193 indicates a path of a second publish message (nid=e→f→g→terminal 114) (illustrated in detail in FIG. 7).

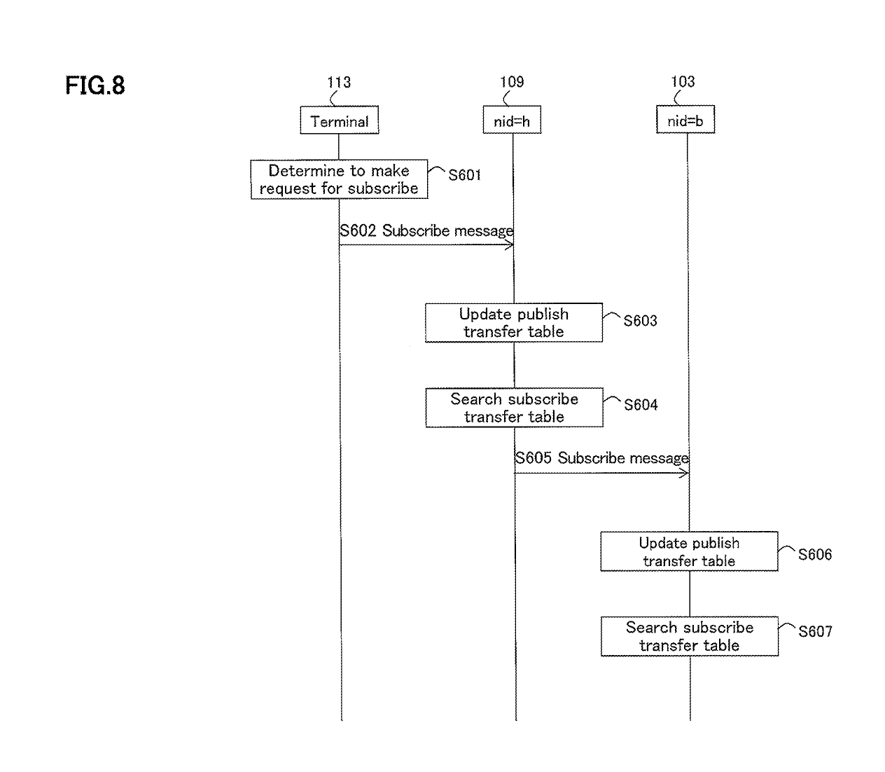

A dashed arrow 194 indicates a path of a second subscribe message (terminal 113→nid=h→b) (illustrated in detail in FIG. 8).

A dashed arrow 195 indicates an extended path of the second subscribe message (nid=b→a→terminal 101).

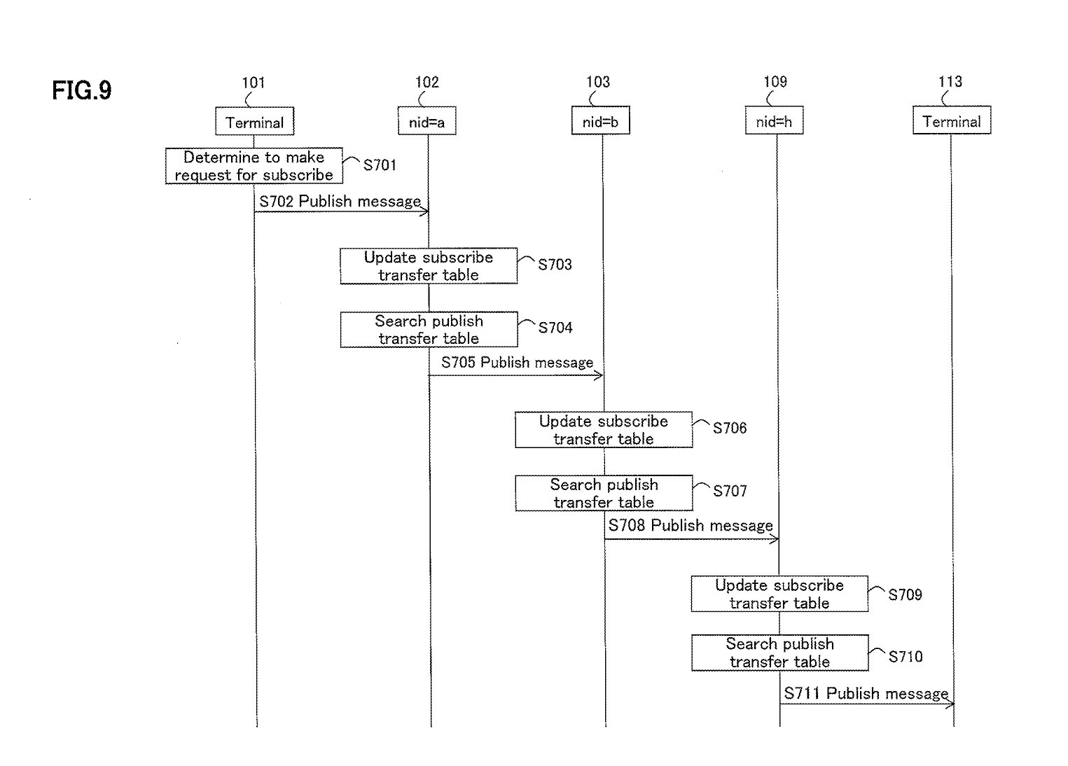

A solid arrow 196 indicates a path of a third publish message (nid=b→h→terminal 113) (illustrated in detail in FIG. 9).

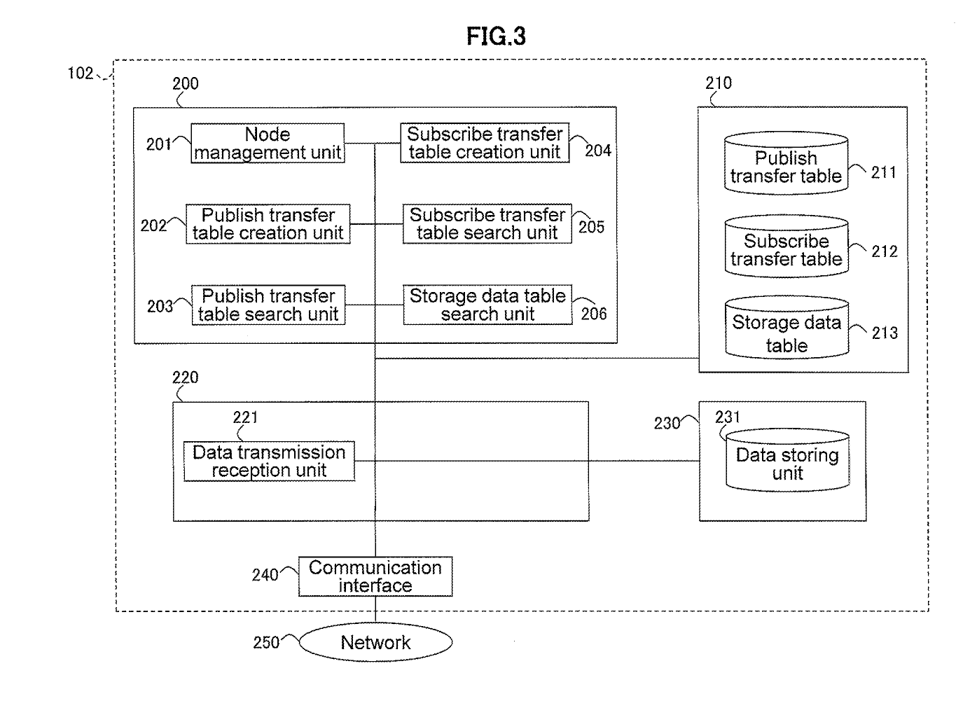

FIG. 3 is a diagram illustrating a configuration of a node device.

Each of the nodes such as the node 102 includes a control processing unit 200, a control data storage unit 210, a data transfer unit 220, a data storage unit 230, and a communication interface 240 for being connected to a network 250. Each of the terminals may include constituent elements same as those of the node.

The control data storage unit 210 includes: a publish transfer table 211 for transferring a publish message; a subscribe transfer table 212 for transferring a subscribe message; and a storage data table 213 for identifying a storage destination of the object 112.

The data transfer unit 220 includes a data transmission reception unit 221. The data transmission reception unit 221 controls transmission and reception of a message.

The data storage unit 230 includes a data storing unit 231. The data storing unit 231 stores therein the object 112.

The communication interface 240 is an interface that intermediates between the constituent elements in the node and a network 250 for connecting to other device.

The control processing unit 200 includes a node management unit 201, a publish transfer table creation unit 202, a publish transfer table search unit 203, a subscribe transfer table creation unit 204, a subscribe transfer table search unit 205, and a storage data table search unit 206.

The node management unit 201 determines whether or not it is necessary to transmit a publish message or a subscribe message.

The storage data table search unit 206: searches the storage data table 213; and thereby identifies a storage destination of the object in the data storing unit 231. Note that the storage data table 213 records therein an oid and information indicating a storage destination in the data storing unit 231 in an object identified by the oid (such as a file name and a data ID), which are associated with each other.

As described next, a path of a publish message (the publish transfer table 211) is set which is similar to a path of a subscribe message but in a reverse direction.

The publish transfer table creation unit 202 creates the publish transfer table 211 based on a received subscribe message.

The publish transfer table search unit 203 searches the publish transfer table 211 for a nexthop, so as to transfer a received publish message.

Similarly, a path of a subscribe message (the subscribe transfer table 212) is set which is similar to a path of a publish message but in a reverse direction.

The subscribe transfer table creation unit 204 creates the subscribe transfer table 212 based on a received publish message.

The subscribe transfer table search unit 205 searches the subscribe transfer table 212 for a nexthop, so as to transfer a received subscribe message.

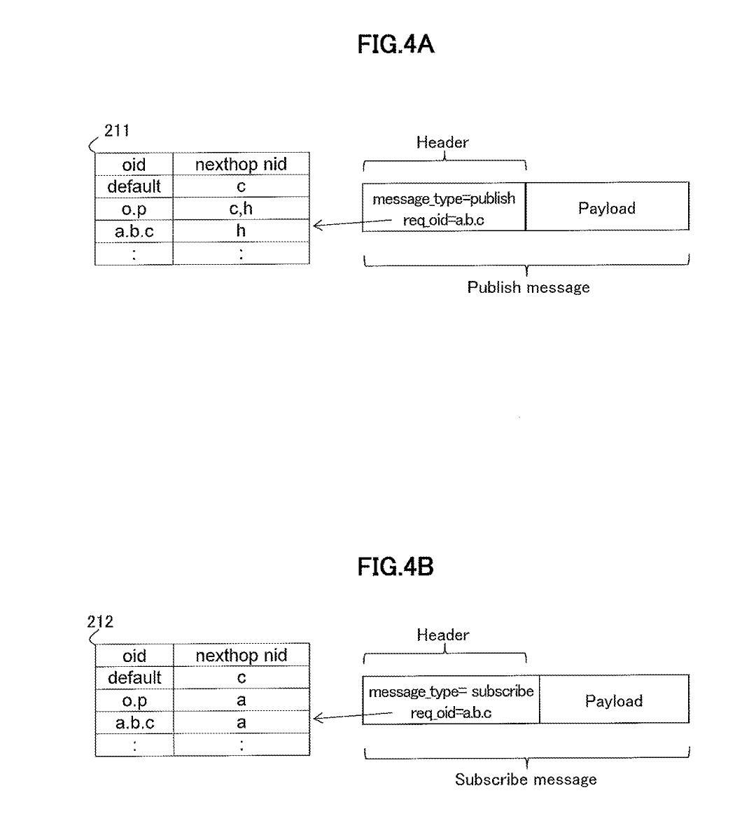

FIG. 4A and FIG. 4B are each an explanatory diagram illustrating a table stored in the node 103 (nid=b).

The publish transfer table 211 of FIG. 4A records therein, for each oid as a target for searching, a node ID of a nexthop thereof (a nexthop nid). Note that, if a plurality of subscriber terminals subscribe for one specific object ID, a plurality of nexthops may be recorded (for example, “nexthop nid=c,h” on the second row). The character “,” in the “c,h” is a separator for separating a plurality of enumerated elements (c and h).

The publish transfer table search unit 203: searches the publish transfer table 211 for a record which matches “req_oid=a.b.c” contained in a header of a publish message (message_type=publish); and determines a nexthop nid(=h) of the searched record as a transfer destination (a nexthop) of the publish message. Note that the character “.” in the “a.b.c” is a separator for separating a plurality of layers constituting an element (which will be described in detail later as hierarchical representation of an oid).

In order to reflect the hierarchical configuration of the node illustrated in FIG. 1 to the push-type communication system, in a case where a transfer table (such as the publish transfer table 211 and the subscribe transfer table 212) fails to determine a transfer destination (nexthop), an upper node viewed from a node of interest (nid=c if viewed from nid=b) is set as a default transfer destination (a nexthop) thereof.

The subscribe transfer table 212 of FIG. 4B records therein a node ID (a nexthop nid) for each oid as a target for the searching.

The subscribe transfer table search unit 205: searches the subscribe transfer table 212 for a record which matches “req_oid=a.b.c” contained in a header of a subscribe message (message_type=subscribe); and determines the nexthop nid(=a) in the searched record as a transfer destination (a nexthop) of the subscribe message.

Similar to the publish transfer table search unit 203, the subscribe transfer table search unit 205 has an upper node viewed from a node of interest (nid=c viewed from nid=b as a default transfer destination).

Note that a header of the publish message or the subscribe message records therein information used for reference when the message is transferred. Also, a payload thereof records therein data in the object 112.

In creating a message, a node or a terminal assigns thereto a header as exemplified below.

In “message_type” on the first row, either “publish” representing a publish message or “subscribe” representing a subscribe message is stored as a type of a message of interest.

In “req_oid” on the second row, an object ID is stored as an ID of an object targeted for a publish or a subscribe.

Additionally, though not illustrated, the header may contain information on a transmission source (a publisher terminal or a subscriber terminal) of a message, information on an order of nodes through which the message passes (for example, nid=a,b,c,e), and the like.

Next is described hierarchical representation of an oid. The oid (=a.b.c, for example) is constituted by a plurality of elements (a, b, and c, for example) which are joined using separators (“.”, for example). In such hierarchical representation, for example, the nearer to a head of the elements (more leftward) an element of interest is situated, the higher a layer in the hierarchy to which the element of interest belongs; and, the nearer to an end of the elements (more rightward), the lower. A processing of determining whether or not entries in the hierarchical representation match is performed, from which one of the following outcomes (1) to (3) is obtained.

(1) In a case of not matching: For example, a search key “a.b.c” and a search target “d.e.f” are compared starting from respective heads “a” and “d” positioned at respective tops, which do not match with each other. The search key and the search target do not thus share same data contents and are not determined to match (neither partial matching nor complete matching).

(2) In a case of partial matching: For example, the search key “a.b.c” and a search target “a.b” are compared starting from respective heads and are found to match in regard to respective first two portions of “a.b” but not in regard to an end portion of “c” of the search key. In such a case that the portions “a.b” extracted from the first two portions of the search key “a.b.c” partially matches the “a.b” of the search target, it is called partial matching. Note that the partial portions “a.b” extracted starting from the head of the hierarchical representation “a.b.c” is referred to as a “prefix” hereinafter.

(3) In a case of complete matching: For example, the search key “a.b.c” and a search target “a.b.c” are compared and are found to match with each other from respective heads to ends. In this case, it is called a complete matching.

If the search key is “a.b.c” and also if a first search target “a”, a second search target “a.b”, and a third search target “a.b.c” are present in a same transfer table, a search target having the most consistent portions with the search key “a.b.c” is first selected (so-called the “longest match rule”). In this example, if a search is performed with the search key “a.b.c”, the third search target having the complete matching is the first choice; the second search target having the partial matching, the second; and the first search target having the partial matching, the last.

FIG. 5 is a sequence diagram illustrating a routing processing of a first subscribe message.

In S301, the node management unit 201 of the terminal 114 determines that a subscribe of the object 112 (oid=a.b.c) be requested. The determination is made in response to an operation by a user, a timer of a terminal, a trigger caused by an external factor, or the like.

In S302, the node management unit 201 of the terminal 114 transmits a subscribe message (message_type=subscribe, req_oid=a.b.c) determined in S301, to a node 108 via the data transmission reception unit 221.

Each of the nodes concerned then performs <Procedure 1a>, <Procedure 2a>, and <Procedure 3a> in this order.

<Procedure 1a> The publish transfer table creation unit 202 updates the publish transfer table 211 of its own, based on a subscribe message received from an adjacent node (or an adjacent terminal) on an upstream side of itself by one hop (rewrites a newly-added entry or an existing entry) (in FIG. 5, “Update publish transfer table” in S303, S306, and S309).

An “oid” of an entry to be updated is “req_oid” contained in the subscribe message.

A “nexthop nid” of the entry to be updated is a nid of an adjacent node (or an adjacent terminal) which is located on an upstream side of itself by one hop and has transmitted the subscribe message. In S306, for example, the “nexthop nid” of an entry to be updated in the publish transfer table 211 of the node 107 (nid=f) is a nid of an adjacent node (nid=g) located on an upstream side of itself (nid=f) by one hop.

<Procedure 2a> The subscribe transfer table search unit 205: searches the subscribe transfer table 212 for the “req_oid” contained in the subscribe message in Procedure 1a; and thereby identifies a transfer destination (nexthop nid) to an adjacent node (or an adjacent terminal) on a downstream side of itself by one hop (in FIG. 5, “Search subscribe transfer table” in S304, S307, and S310).

In S307, for example, a search of the subscribe transfer table 212 in the node 107 (nid=f) is yet to find neither complete matching nor partial matching with “oid=a.b.c” at this point. Thus, an upper node (nid=e) of the node itself (nid=f) is determined as a default transfer destination.

<Procedure 3a> The data transmission reception unit 221 transfers the subscribe message to the transfer destination determined in Procedure 2a via the communication interface 240 (in FIGS. 5, S305 and S308).

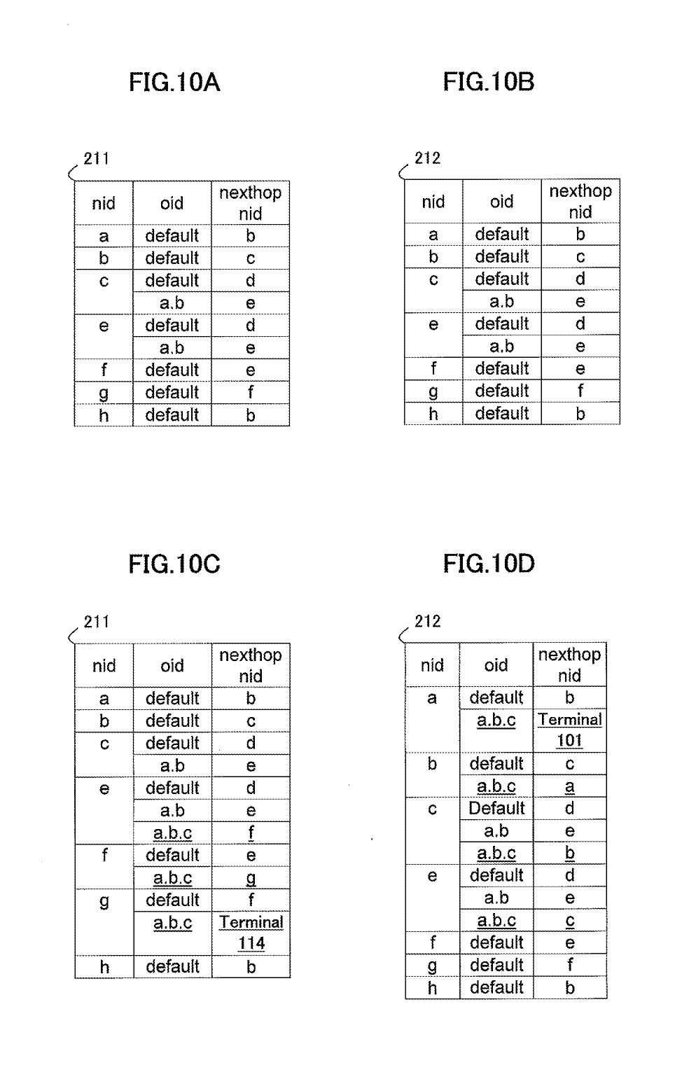

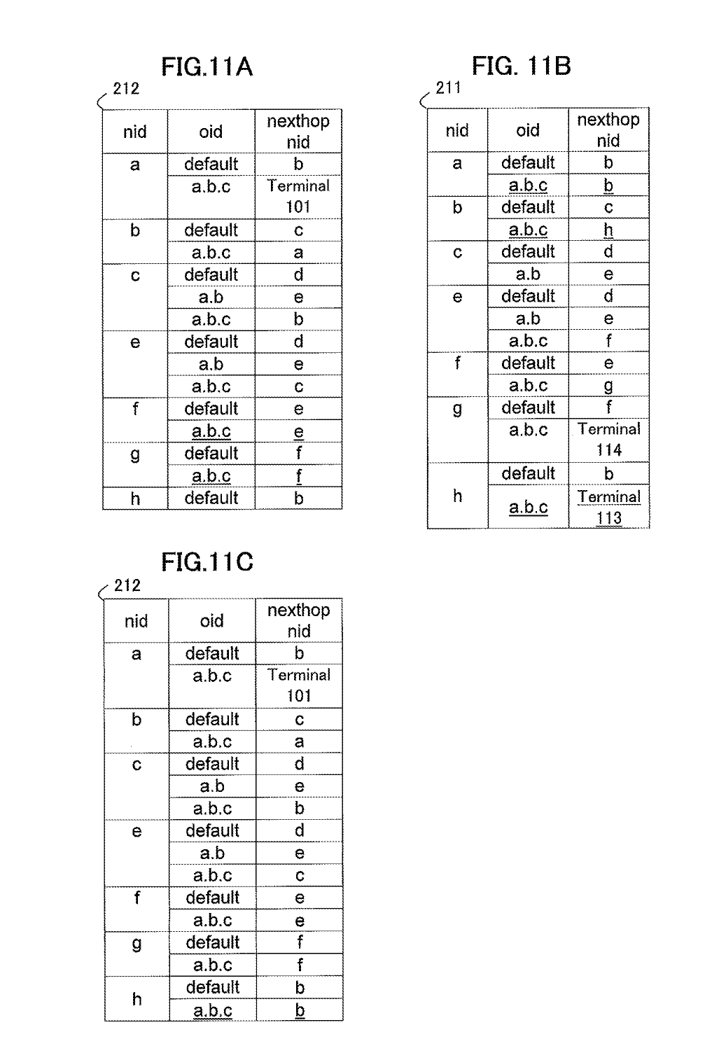

FIGS. 10A to 10D and FIGS. 11A to 11C are diagrams illustrating respective snapshots in which contents of the tables (the publish transfer table 211 and the subscribe transfer table 212) at particular points in time when the messages illustrated in FIG. 2 are processed are described for each node.

Execution of the processings illustrated in FIG. 5 updates the contents of the publish transfer table 211 from those illustrated in FIG. 10A to those illustrated in FIG. 100 (Updated items are underlined; hereinafter the same). The contents of the publish transfer table 211 of each of the nodes through which the first subscribe message passes along the path indicated by the dashed arrow 191 are updated as described in Procedure 1a. For example, the publish transfer table 211 in the node 107 (nid=f) is added with, besides the already-existing “default” entries, new entries of “oid=a.b.c, nexthop nid=g” in Procedure 1a in S306 (FIG. 10C).

On the other hand, the contents of the subscribe transfer table 212 remain unchanged from those illustrated in FIG. 10B which are those before execution of the processings of FIG. 5, because the processing of FIG. 5 is a processing of just transmitting a subscribe message.

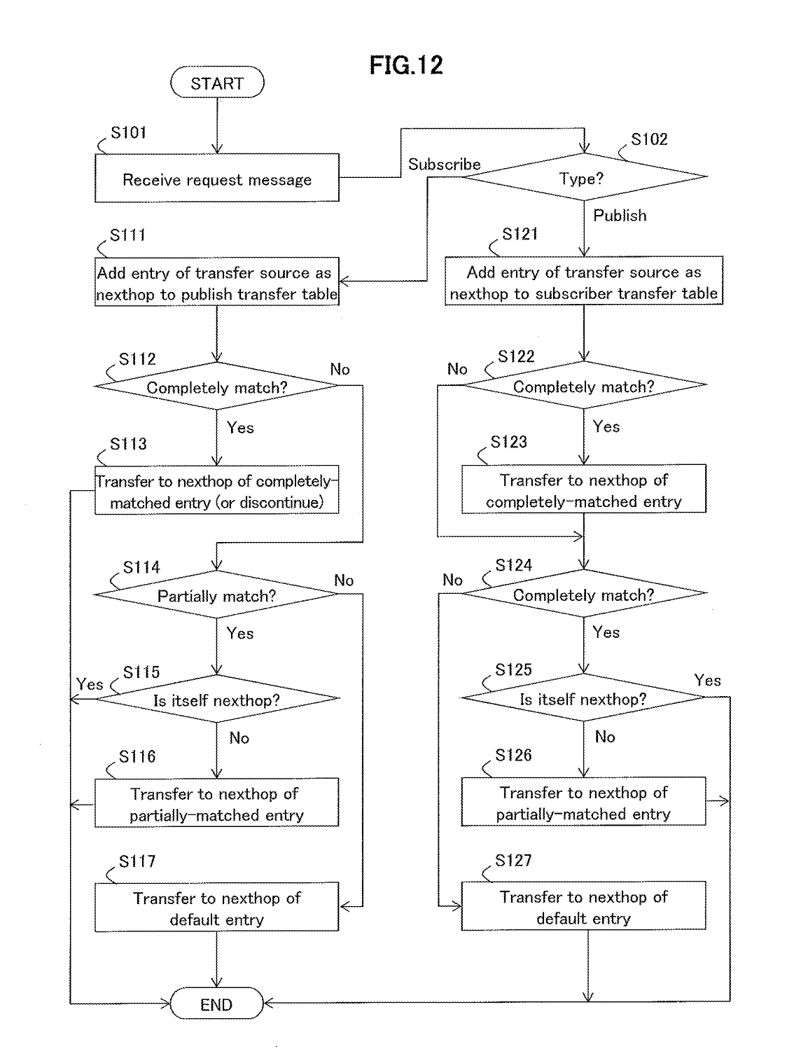

In S310 in Procedure 2a, the processing is terminated without performing Procedure 3a. This is because, in the publish transfer table 211 in the node 106 (nid=e), an entry which makes itself a nexthop nid (oid=a.b) (an entry which partially matches oid=a.b.c) is present (see S115 of FIG. 12 to be described in detail later).

FIG. 6 is a sequence diagram illustrating a routing processing of the first publish message.

In S401, the node management unit 201 of the terminal 101 determines that a publish of the object 112 (oid=a.b.c) be requested. The determination is made in response to an operation by a user, a timer of a terminal, a trigger caused by an external factor, or the like.

In S402, the node management unit 201 of the terminal 101 transmits the publish message (message_type=publish, req_oid=a.b.c, add the object 112 to a payload) determined in S401 to the node 102 via the data transmission reception unit 221.

Each of the nodes concerned then performs <Procedure 1b>, <Procedure 2b>, and <Procedure 3b> in this order.

<Procedure 1b> The subscribe transfer table creation unit 204 updates the subscribe transfer table 212 of its own (rewrites a newly-added entry or an existing entry), based on the publish message received from an adjacent node (or an adjacent terminal) located on an upstream side of itself by one hop (In FIG. 6, “Update subscribe transfer table” in S403, S406, S409, and S412).

The “oid” of an entry to be updated is “req_oid” contained in the publish message.

The “nexthop nid” of the entry to be updated is a nid of an adjacent node (or an adjacent terminal) which is located on an upstream of itself by one hop and has transmitted the publish message. In S406, for example, the “nexthop nid” of the entry to be updated in the subscribe transfer table 212 in the node 103 (nid=b) is a nid of an adjacent node (nid=a) located on an upstream side of itself (nid=b) by one hop.

<Procedure 2b> The publish transfer table search unit 203: searches the publish transfer table 211 for the “req_oid” contained in the publish message in Procedure 1b; and thereby identifies a transfer destination (a nexthop nid) to an adjacent node (or an adjacent terminal) on a downstream side of itself by one hop (in FIG. 6, “Search publish transfer table” in S404, S407, S410, and S413).

In S407, for example, a search of the publish transfer table 211 in the node 103 (nid=b) is yet to find neither complete matching nor partial matching with “oid=a.b.c” at this point. Thus, an upper node (nid=c) viewed from the node of its own (nid=b) is determined as a default transfer destination.

<Procedure 3b> The data transmission reception unit 221 transfers the publish message to the transfer destination determined in Procedure 2b via the communication interface 240 (in FIG. 6, S405, S408, and S411).

FIG. 10D is a diagram illustrating the subscribe transfer table 212 after execution of the processing of FIG. 6. Compared to FIG. 10B before the execution of the processing of FIG. 6, in the subscribe transfer table 212 of FIG. 10D, the node on the path of the first publish message (terminal 101→nid=a→b→c→e, indicated by the solid arrow 192 in FIG. 2) is updated (an entry add processing of oid=a.b.c) using Procedure 1b (Updated items are underlined).

FIG. 7 is a sequence diagram illustrating a routing processing of a second publish message. Respective components on the path of the second publish message from the node 106 (nid=e) to the terminal 114 transfer the first publish message received in S411 as the second publish message in a reverse direction of the path of the first subscribe message (indicated by the dashed arrow 191).

A processing of updating the subscribe transfer table 212 in Procedure 1b is performed in S502, S505, and S508.

A processing of searching the publish transfer table 211 in Procedure 2b is performed in S503, S506, and S509.

A processing of transferring the publish message in Procedure 3b is performed in S501, S504, and S507.

FIG. 11A is a diagram illustrating the subscribe transfer table 212 after execution of the processing of FIG. 7. Compared to FIG. 10D before the execution of the processing of FIG. 7, in the subscribe transfer table 212 of FIG. 11A, the nodes of nid=f,g on the path of the second publish message are updated (an entry add processing of oid=a.b.c) using Procedure 1b (Updated items are underlined).

FIG. 8 is a sequence diagram illustrating a routing processing of the second subscribe message.

In S601, similarly to S301, the node management unit 201 of the terminal 113 determines that a subscribe of the object 112 (oid=a.b.c) be requested.

Respective components on the path of the second subscribe message from the terminal 113 to the node 103 (nid=b) (indicated by the dashed arrow 194) transfer the second subscribe message determined in S601.

A processing of updating the publish transfer table 211 in Procedure 1a is performed as “Update publish transfer table” in S603 and S606.

A processing of searching the subscribe transfer table 212 in Procedure 2a is performed as “Search subscribe transfer table” in S604 and S607.

A processing of transferring the subscribe message in Procedure 3a is performed in S602 and S605.

Note that, in S607, if an entry which completely matches oid=a.b.c is present in the subscribe transfer table 212, the subscribe transfer table search unit 205 of the node 103 (nid=b) terminates the processing of transferring the publish message (a discontinuing processing of S113 in FIG. 12 to be described hereinafter).

Alternatively, the data transmission reception unit 221 of the node 103 (nid=b) may continue the processing of transferring the publish message to a “nexthop nid” (herein, nid=a) indicated by an entry which completely matches (a transferring processing of S113 in FIG. 12 to be described hereinafter). If the processing of transferring the second subscribe message is continued (extended) as indicated by the dashed arrow 195, the second subscribe message is transmitted to the terminal 101 as a publisher terminal.

FIG. 11B is a diagram illustrating the publish transfer table 211 after the execution of the processing of FIG. 8. Compared to FIG. 10C before the execution of the processing of FIG. 8, in the publish transfer table 211 of FIG. 11B, the nodes of nid=a,b,h on the path of the second subscribe message are updated (an entry add processing of oid=a.b.c) using Procedure 1b (Updated items are underlined).

FIG. 9 is a sequence diagram illustrating a routing processing of the third publish message.

The third publish message: branches from in-between the first publish message (nid=b); and reaches the terminal 113 which is a transmitter (a subscriber terminal) of the second subscribe message along with the solid arrow 196.

In S701 to S706, processings same as those in S401 to S406 (before the branching of the first publish message) are performed.

In S707, the publish transfer table search unit 203 of the node 103 (nid=b): references the publish transfer table 211 of its own; and, because two transfer destinations of the first publish message are present (nexthop nid=c when oid=default, and nexthop nid=h when oid=a.b.c), branches out (copies) the publish message into the first publish message to be transmitted to nid=c and into the third publish message to be transmitted to nid=h.

The third publish message follows a path similar to the path of the second subscribe message, but in a reverse direction, and finally reaches the terminal 113.

A processing of updating the subscribe transfer table 212 in Procedure 1b is performed in S709.

A processing of searching the publish transfer table 211 in Procedure 2b is performed in S710.

A processing of transferring the publish message in Procedure 3b is performed in S708 and S711.

FIG. 11C is a diagram illustrating the subscribe transfer table 212 after the processing illustrated in FIG. 9. Compared to FIG. 11A before execution of the processing illustrated in FIG. 9, in the subscribe transfer table 212 of FIG. 11C, the nodes of nid=h on the path of the third publish message are updated (an entry add processing of oid=a.b.c) using Procedure 1a (Updated items are underlined).

FIG. 12 is a flowchart illustrating processings performed by the node device.

In S101, the data transmission reception unit 221 receives a request message.

In S102, depending on a type of the received request message (message_type), the node management unit 201 advances the processing to S111 if the type is of a subscribe message in S101; and, to S121, if of a publish message.

In S111, the publish transfer table creation unit 202 adds an entry of a transfer source of the subscribe message in S101 as a nexthop, to the publish transfer table 211 (Procedure 1a).

In S112, the subscribe transfer table search unit 205 determines whether or not an entry which completely matches an oid of the subscribe message is present in the subscribe transfer table 212. If yes in S112, the processing advances to S113, and, if no, to S114.

In S113, the data transmission reception unit 221 transfers the subscribe message to the nexthop of the completely-matched entry in S112. Alternatively, the data transmission reception unit 221 discontinues (does not perform) the transferring and terminates the processing.

In S114, the subscribe transfer table search unit 205 determines whether or not an entry which partially matches the oid of the subscribe message is present in the subscribe transfer table 212. If yes in S114, the processing advances to S115, and, if no, to S117.

In S115, the subscribe transfer table search unit 205 determines whether or not a nexthop of the partially-matched entry in S114 is the node of its own. If yes in S115, the subscribe transfer table search unit 205 terminates the processing, and, if no, advances the processing to S116.

In S116, the data transmission reception unit 221 transfers the subscribe message to the nexthop of the partially-matched entry in S114.

In S117, the data transmission reception unit 221 transfers the subscribe message to a nexthop of a default entry.

In S121, the subscribe transfer table creation unit 204 adds an entry of a transfer source of the publish message in S101 as a nexthop, to the subscribe transfer table 212 (Procedure 1b).

In S122, the publish transfer table search unit 203 determines whether or not an entry which completely matches an oid of the publish message is present in the publish transfer table 211. If yes in S122, the publish transfer table search unit 203 advances the processing to S123, and, if no, to S124.

In S123, the data transmission reception unit 221 transfers the publish message to a nexthop of the completely-matched entry in S122, and advances the processing to S123.

In S124, the publish transfer table search unit 203 determines an entry which partially matches an oid of the publish message is present in the publish transfer table 211. If yes in S124, the publish transfer table search unit 203 advances the processing to S125, and, if no, to S127.

In S125, the publish transfer table search unit 203 determines whether or not a nexthop of the partially-matched entry in S124 is the node of its own. If yes in S125, the publish transfer table search unit 203 terminates the processing, and, if no, advances the processing to S126.

In S126, the data transmission reception unit 221 transfers the publish message to the nexthop of the partially-matched entry in S124.

In S127, the data transmission reception unit 221 transfers the publish message to a nexthop of the default entry.

One of major features in the above-described embodiment is that, when a publish message is routed, information on the routing is recorded in the subscribe transfer table 212, and the subscribe message is then routed, based on the recorded information on the routing in the subscribe transfer table 212.

This allows the subscribe messages to take various different paths without passing through a node at which matching is otherwise performed, compared to a technique of matching the publish message and the subscribe message. This can prevent performance of a push-type communication system from being degraded, due to a load concentrated on a matching node.

In a communication system of a conventional push-type, on the other hand, if a frequency of transmitting subscribe messages is high, the subscribe messages concentrate on a matching node, which generates a large transaction load.

For example, in Non-Patent Document 1, a location ID of a subscriber is registered when a subscribe message reaches a node which performs a name resolution of a hierarchical DHT (Distributed Hash Table) (a name resolution node). If a frequency of transmitting the subscribe messages is high, a transaction load of the name resolution node is increased.

In Non-Patent Document 2, subscribe messages are concentrated on a root node which is located topmost of a hierarchical topology. This increases a transaction load.

Non-Patent Document 3, subscribe messages are concentrated on a rendezvous system. This increases a transaction load.

In Patent Document 1, updates of routing information caused by a subscribe are exchanged between nodes by means of broadcasting or the like. This generates a large volume of transactions, which increases load.

In this embodiment, however, the second subscribe message which joins the path of the first publish message at the node 103 (nid=b) does not proceed to the node 106 (nid=e) as the first subscribe message does but discontinues the transfer of the second subscribe message or proceeds to the terminal 101 which is a publisher terminal. This can prevent the subscribe messages from being concentrated on the node 106 (nid=e).

Although the present disclosure has been described with reference to exemplary embodiments, those skilled in the art will recognize that various changes and modifications may be made in form and detail without departing from the spirit and scope of the claimed subject matter.

Part of a configuration of the embodiments can be substituted by or added to that of another example.

Part of a configuration of the embodiments can be added with or substituted by another configuration or can be deleted. Part or all of a configuration, a function, a processing unit, or the like may be embodied by hardware by means of, for example, designing of integrated circuits.

The above-described configuration, function, or the like may be embodied by software in which, for example, a processor interprets and executes a program which realizes the function.

Data of a program, a table, a file, and the like for realizing such a function can be stored in a storage device including a memory, a hard disk, and a SSD (Solid State Drive) or in a storage medium including an IC (Integrated Circuit) card, an SD card, and a DVD (Digital Versatile Disc).

In the disclosure, only control lines and information lines which are deemed necessary for explanation are illustrated, and not all of them which may be necessary as a product are illustrated. In practice, almost all constituent elements are connected to each other.

1. A communication system which is constituted by a plurality of nodes connected to each other via a network, comprising:
a first node which is one of a plurality of the nodes used for the communication system, that receives a publish message for requesting for transmission of an object, from a publisher terminal;
a second node which is different from the first node of a plurality of the nodes,
wherein each of the nodes from the first node to the second node
has a storage unit of its own in which first routing information showing a nexthop node as a transfer destination of the publish message is recorded,
performs a first routing in which the publish message is transferred to the nexthop which is obtained from the first routing information, and
records, in the storage unit of its own, an object ID of the publish message transferred using the first routing, and second routing information in which an adjacent node having transferred the publish message to the node itself is determined as a nexthop; and
a third node which is different from the first node and the second node of a plurality of the nodes, that receives a subscribe message for requesting for receipt of the object, from a subscriber terminal,
wherein each of the nodes from the third node to the first node
performs a second routing in which the subscribe message is transferred to the nexthop which is obtained by searching the second routing information for a object ID of the subscribe message or to a pre-set default nexthop, and
records, in the storage unit of its own, the object ID of the subscribe message transferred using the second routing, and third routing information in which an adjacent node having transferred the subscribe message to the node itself is determined as a nexthop.

2. The communication system according to claim 1,
wherein the first node receives the publish message of the object from the publisher terminal one more time, and
wherein each of the nodes from the first node to the third node performs a third routing in which the publish message having been received one more time is transferred to a nexthop which is obtained by searching the third routing information for an object ID of the publish message having been received one more time.

3. The communication system according to claim 1,
wherein, from among the nodes from the third node to the first node each of which performs the second routing, a node which has successfully obtained the object ID of the subscribe message from the second routing information discontinues the second routing.

4. The communication system according to claim 2,
wherein, from among the nodes from the third node to the first node each of which performs the third routing, a node which has searched the third routing information and has obtained a plurality of nexthops, copies and transfers the received publish message to each of a plurality of the obtained nexthops.

5. A node device used for a communication system which is constituted by a plurality of nodes connected to each other via a network, comprising:
a publish transfer table that associates an object ID of a publish message for requesting for transmission of an object, with a nexthop as a transfer destination toward a subscriber terminal of the publish message;
a storage unit that stores therein a subscribe transfer table which associates an object ID of a subscribe message for requesting for reception of the object, with a nexthop as a transfer destination toward a publisher terminal of the subscribe message;
a subscribe transfer table creation unit that stores, in the subscribe transfer table, an object ID of the received publish message, and an adjacent node which has transferred the publish message to itself, as a nexthop, in association with each other;
a publish transfer table search unit that searches the publish transfer table for an object ID of the publish message and identifies a nexthop to which the publish message is transferred;
a publish transfer table creation unit that stores, in the publish transfer table, an object ID of the received subscribe message, and an adjacent node which has transferred the subscribe message to itself, as a nexthop, in association with each other; and
a subscribe transfer table search unit that searches the subscribe transfer table for an object ID of the subscribe message and identifies a nexthop to which the subscribe message is transferred.

6. A non-transitory computer-readable medium storing a node program, the node program for causing a computer to serve as the subscribe transfer table creation unit, the publish transfer table search unit, the publish transfer table creation unit, and the subscribe transfer table search unit of the node device according to claim 5.

7. A non-transitory computer-readable medium storing a communication program used for a communication system which is constituted by a plurality of nodes connected to each other via a network, the communication program for causing a computer to make, by being loaded and executed by a plurality of the nodes:
a first node of a plurality of the nodes receive a publish message for requesting for transmission of an object, from a publisher terminal;
each of nodes from the first node to a second node which is different from the first node of a plurality of the nodes
record first routing information indicating a node as a nexthop which is a transfer destination of the publish message, in a storage unit of its own,
perform a first routing in which the publish message is transferred to the nexthop which is obtained from the first routing information, and
record an object ID of the publish message transferred using the first routing, and second routing information in which an adjacent node having transferred the publish message to the node itself is determined as a nexthop, in a storage unit of its own;
a third node which is different from the first and second nodes of a plurality of the nodes receive a subscribe message for requesting for reception of the object, from a subscriber terminal; and
each of the nodes from the third node to the first node to
perform a second routing in which the subscribe message is transferred to the nexthop obtained by the object ID of the subscribe message from the second routing information or a pre-set default nexthop, and
record, in a storage unit of its own, an object ID of the subscribe message transferred using the second routing, and third routing information in which an adjacent node having transferred the subscribe message to the node itself is determined as a nexthop.

8. The non-transitory computer-readable medium storing the communication program according to claim 7,
wherein the communication program causes the computer to make
the first node receive the publish message of the object from the publisher terminal one more time, and
each of the nodes from the first node to the third node perform a third routing in which the publish message having been received one more time is transferred to a nexthop which is obtained by searching the object ID of the publish message which has been received from the third routing information one more time.

9. The non-transitory computer-readable medium storing the communication program according to claim 7,
wherein the communication program causes the computer to make, from among the nodes from the third node to the first node each of which performs the second routing, a node which has successfully searched the object ID of the subscribe message from the second routing information, to discontinue the second routing.

10. The non-transitory computer-readable medium storing the communication program according to claim 8,
wherein the communication program causes the computer to make, from among the nodes from the third node to the first node each of which performs the third routing, a node which has searched the third routing information and has obtained a plurality of nexthops copy and transfer the received publish message to each of a plurality of the obtained nodes.
